(19) United States
(12) Patent Application Publication
(10) Pub. No.: US 2008/0022079 A1
(43) Pub. Date: Jan. 24, 2008

(54) EXECUTING AN ALLGATHER OPERATION WITH AN ALLTOALLV OPERATION IN A PARALLEL COMPUTER

(76) Inventors: Charles J. Archer, Rochester, MN (US); Philip Heidelberger, Cortlandt Manor, NY (US); Jose Eduardo Moreira, Yorktown Heights, NY (US); Joseph D. Ratterman, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/459,387

(22) Filed: Jul. 24, 2006

(51) Int. Cl. G06F 9/44

(52) U.S. Cl. 712/225

(57) ABSTRACT

Executing an allgather operation on a parallel computer, including executing an alltoallv operation with a list of send displacements, where each send displacement is a send buffer segment pointer, each send displacement points to the same segment of a send buffer, the parallel computer includes a plurality of compute nodes, each compute node includes a send buffer, the compute nodes are organized into at least one operational group of compute nodes for collective operations, each compute node in the operational group is assigned a unique rank, and each send buffer is segmented according to the ranks.

### STATEMENT REGARDING FEDERALLY SPONSORED RESEARCH OR DEVELOPMENT

This invention was made with Government support under Contract No. B519700 awarded by the Department of Energy. The Government has certain rights in this invention.

### BACKGROUND OF THE INVENTION

1. Field of the Invention

The field of the invention is data processing, or, more specifically, methods and products for executing an allgather operation on a parallel computer.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Parallel computing is an area of computer technology that has experienced advances. Parallel computing is the simultaneous execution of the same task (split up and specially adapted) on multiple processors in order to obtain results faster. Parallel computing is based on the fact that the process of solving a problem usually can be divided into smaller tasks, which may be carried out simultaneously with some coordination.

Parallel computers execute parallel algorithms. A parallel algorithm can be split up to be executed a piece at a time on many different processing devices, and then put back together again at the end to get a data processing result. Some algorithms are easy to divide up into pieces. Splitting up the job of checking all of the numbers from one to a hundred thousand to see which are primes could be done, for example, by assigning a subset of the numbers to each available processor, and then putting the list of positive results back together. In this specification, the multiple processing devices that execute the individual pieces of a parallel program are referred to as ‘compute nodes.’ A parallel computer is composed of compute nodes and other processing nodes as well, including, for example, input/output (‘I/O’) nodes, and service nodes.

Parallel algorithms are valuable because it is faster to perform some kinds of large computing tasks via a parallel algorithm than it is via a serial (non-parallel) algorithm, because of the way modern processors work. It is far more difficult to construct a computer with a single fast processor than one with many slow processors with the same throughput. There are also certain theoretical limits to the potential speed of serial processors. On the other hand, every parallel algorithm has a serial part and so parallel algorithms have a saturation point. After that point adding more processors does not yield any more throughput but only increases the overhead and cost.

Parallel algorithms are designed also to optimize one more resource the data communications requirements among the nodes of a parallel computer. There are two ways parallel processors communicate, shared memory or message passing. Shared memory processing needs additional locking for the data and imposes the overhead of additional processor and bus cycles and also serializes some portion of the algorithm.

Message passing processing uses high-speed data communications networks and message buffers, but this communication adds transfer overhead on the data communications networks as well as additional memory need for message buffers and latency in the data communications among nodes. Designs of parallel computers use specially designed data communications links so that the communication overhead will be small but it is the parallel algorithm that decides the volume of the traffic.

Many data communications network architectures are used for message passing among nodes in parallel computers. Compute nodes may be organized in a network as a ‘torus’ or ‘mesh,’ for example. Also, compute nodes may be organized in a network as a tree. A torus network connects the nodes in a three-dimensional mesh with wrap around links. Every node is connected to its six neighbors through this torus network, and each node is addressed by its x,y,z coordinate in the mesh. In a tree network, the nodes typically are connected into a binary tree: each node has a parent, and two children (although some nodes may only have zero children or one child, depending on the hardware configuration). In computers that use a torus and a tree network, the two networks typically are implemented independently of one another, with separate routing circuits, separate physical links, and separate message buffers.

A torus network lends itself to point to point operations, but a tree network typically is inefficient in point to point communication. A tree network, however, does provide high bandwidth and low latency for certain collective operations, message passing operations where all compute nodes participate simultaneously, such as, for example, an allgather operation. An allgather operation is a collective operation on an operational group of compute nodes that gathers data from all compute nodes in the operational group, concatenates the gathered data into a memory buffer in rank order, and provides the entire contents of the memory buffer to all compute nodes in the operational group. Because thousands of nodes may participate in collective operations on a parallel computer, executing an allgather operation on a parallel computer is always a challenge. A typical prior art algorithm for carrying out an allgather operation is for each computer node in the operational group to broadcast its contribution of data to all the compute nodes in the operational group. If the group is large, and such groups may contain thousands of compute nodes, then the data communications cost of such an algorithm is substantial.

### SUMMARY OF THE INVENTION

Methods and computer program products are disclosed for executing an allgather operation on a parallel computer that include executing an alltoallv operation with a list of send displacements, where each send displacement is a send buffer segment pointer, each send displacement points to the same segment of a send buffer, the parallel computer includes a plurality of compute nodes, each compute node includes a send buffer, the compute nodes are organized into at least one operational group of compute nodes for collective operations, each compute node in the operational group is assigned a unique rank, and each send buffer is segmented according to the ranks.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 illustrates an exemplary system for computer executing an allgather operation on a parallel computer according to embodiments of the present invention.

FIG. 2 sets forth a block diagram of an exemplary compute node useful in executing an allgather operation on a parallel computer according to embodiments of the present invention.

FIG. 3A illustrates an exemplary Point To Point Adapter useful in systems that execute an allgather operation on a parallel computer according to embodiments of the present invention.

FIG. 3B illustrates an exemplary Collective Operations Adapter useful in systems that execute an allgather operation on a parallel computer according to embodiments of the present invention.

FIG. 4 illustrates an exemplary data communications network optimized for point to point operations.

FIG. 5 illustrates an exemplary data communications network optimized for collective operations.

FIG. 6 sets forth a flow chart illustrating an exemplary method of executing an allgather operation on a parallel computer according to embodiments of the present invention.

FIG. 7A illustrates the function of an allgather operation as defined in the MPI standard.

FIG. 7B illustrates the function of an alltoallv operation as defined in the MPI standard.

FIG. 7C sets forth a block diagram of an exemplary allgather operation executed with an alltoallv according to embodiments of the present invention.

FIG. 7D sets forth a block diagram of a further exemplary allgather operation executed with an alltoallv according to embodiments of the present invention.

FIG. 8 sets forth a block diagram illustrating execution of an example alltoallv operation on a compute node of a parallel computer according to embodiments of the present invention.

FIG. 9 sets forth a flow chart illustrating a further exemplary method for executing an allgather operation in a parallel computer according to embodiments of the present invention.

FIG. 10 sets forth a line drawing of an exemplary data communications network of a parallel computer upon which the alltoallv of FIG. 9 may be implemented.

### DETAILED DESCRIPTION OF EXEMPLARY EMBODIMENTS

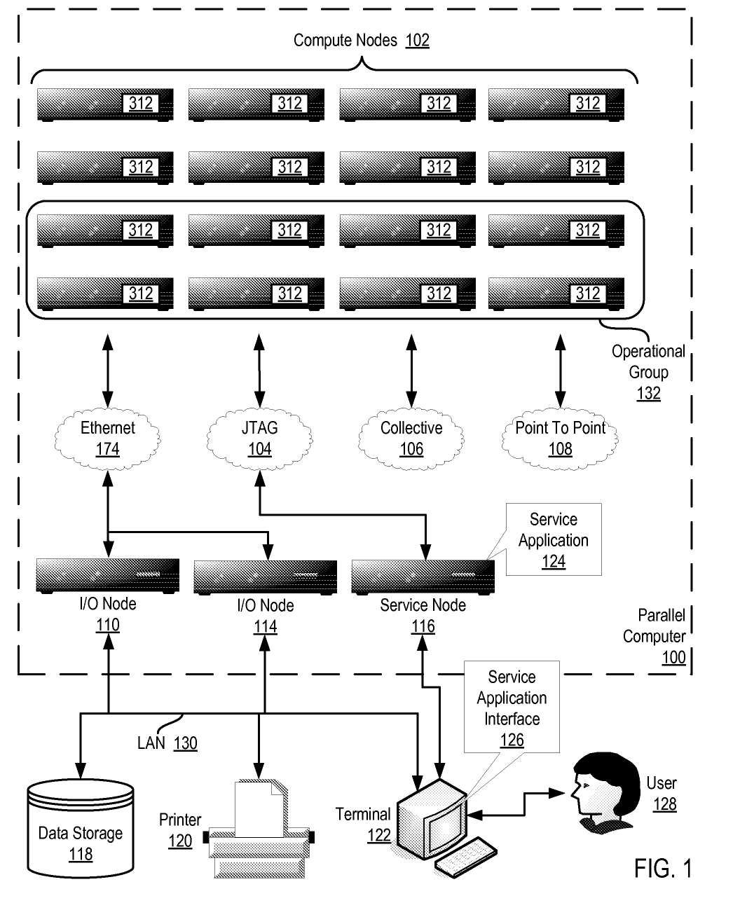

Exemplary methods and computer program products for executing an allgather operation on a parallel computer according to embodiments of the present invention are described with reference to the accompanying drawings, beginning with FIG. 1. FIG. 1 illustrates an exemplary system for executing an allgather operation on a parallel computer according to embodiments of the present invention. The system of FIG. 1 includes a parallel computer (100), non-volatile memory for the computer in the form of data storage device (118), an output device for the computer in the form of printer (120), and an input/output device for the computer in the form of computer terminal (122).

Parallel computer (100) in the example of FIG. 1 also includes a plurality of compute nodes (102). Each compute node is an automated computing device composed of one or more computer processors, its own computer memory, and its own input/output functionality. The compute nodes (102) are coupled for data communications by several independent data communications networks including a high speed Ethernet network (174), a Joint Test Action Group (‘JTAG’) network (104), a tree network (106) which is optimized for collective operations, and a torus network (108) which is optimized point to point operations. Tree network (106) is a data communications network that includes data communications links connected to the compute nodes so as to organize the compute nodes as a tree. Each data communications network is implemented with data communications links among the compute nodes (102). The data communications links provide data communications for parallel operations among the compute nodes of the parallel computer.

The compute nodes (102) of parallel computer are organized into at least one operational group (132) of compute nodes for collective parallel operations on parallel computer (100). An operational group of compute nodes is the set of compute nodes upon which a collective parallel operation executes. Collective operations are implemented with data communications among the compute nodes of an operational group. Collective operations are those functions that involve all the compute nodes of an operational group. A collective operation is an operation, a message-passing computer program instruction that is executed simultaneously, that is, at approximately the same time, by all the compute nodes in an operational group of compute nodes. Such an operational group may include all the compute nodes in a parallel computer (100) or a subset all the compute nodes. Collective operations are often built around point to point operations. A collective operation requires that all processes on all compute nodes within an operational group call the same collective operation with matching arguments. A ‘broadcast’ is an example of a collective operations for moving data among compute nodes of an operational group. A ‘reduce’ operation is an example of a collective operation that executes arithmetic or logical functions on data distributed among the compute nodes of an operational group. An operational group may be implemented as, for example, an MPI ‘communicator.’

‘MPI’ refers to ‘Message Passing Interface,’ a prior art parallel communications library, a module of computer program instructions for data communications on parallel computers. Examples of prior-art parallel communications libraries that may be improved for executing an allgather operation on a parallel computer according to embodiments of the present invention include MPI and the ‘Parallel Virtual Machine’ (‘PVM’) library. PVM was developed by the University of Tennessee, The Oak Ridge National Laboratory and Emory University. MPI is promulgated by the MPI Forum, an open group with representatives from many organizations that define and maintain the MPI standard. MPI at the time of this writing is a de facto standard for communication among compute nodes running a parallel program on a distributed memory parallel computer. This specification sometimes uses MPI terminology for ease of explanation, although the use of MPI as such is not a requirement or limitation of the present invention.

Each compute node of an operational group is assigned a unit identifier referred to as a ‘rank’ (not shown in FIG. 1). A compute node's rank uniquely identifies the compute node's location in data communications networks both for use in both point to point and also in collective operations. Ranks are typically assigned as integers beginning with rank 0, rank 1, rank 2, and so on. Each compute node (102) in the example of FIG. 1 includes a send buffer (312). Each send buffer is at least one region of computer memory segmented according to the ranks of the compute nodes in an operational group.

Most collective operations are variations or combinations of four basic operations: broadcast, gather, scatter, and reduce. In a broadcast operation, all processes specify the same root process, whose buffer contents will be sent. Processes other than the root specify receive buffers. After the operation, all buffers contain the message from the root process. A scatter operation, like the broadcast operation, is also a one-to-many collective operation. All processes specify the same receive count. The send arguments are only significant to the root process, whose buffer actually contains sendcount*N elements of a given datatype, where N is the number of processes in the given group of compute nodes. The send buffer will be divided equally and dispersed to all processes (including itself). Each compute node is assigned a sequential identifier termed a ‘rank.’ After the operation, the root has sent sendcount data elements to each process in increasing rank order. Rank 0 receives the first sendcount data elements from the send buffer. Rank 1 receives the second sendcount data elements from the send buffer, and so on.

A gather operation is a many-to-one collective operation that is a complete reverse of the description of the scatter operation. That is, a gather is a many-to-one collective operation in which elements of a datatype are gather from the ranked compute nodes into a receive buffer in a root node.

A reduce operation is also a many-to-one collective operation that includes an arithmetic or logical function performed on two data elements. All processes specify the same ‘count’ and the same arithmetic or logical function. After the reduction, all processes have sent count data elements from computer node send buffers to the root process. In a reduction operation, data elements from corresponding send buffer locations are combined pair-wise by arithmetic or logical operations to yield a single corresponding element in the root process's receive buffer. Application specific reduction operations can be defined at runtime. Parallel communications libraries may support predefined operations. MPI, for example, provides the following pre-defined reduction operations:

| | |
|---|---|
| MPI_MAX | maximum |
| MPI_MIN | minimum |
| MPI_SUM | sum |
| MPI_PROD | product |
| MPI_LAND | logical and |
| MPI_BAND | bitwise and |
| MPI_LOR | logical or |
| MPI_BOR | bitwise or |
| MPI_LXOR | logical exclusive or |
| MPI_BXOR | bitwise exclusive or |

The system of FIG. 1 operates generally to execute an allgather operation on a parallel computer according to embodiments of the present invention by executing an alltoallv operation with a list of send displacements, where each send displacement is implemented as a send buffer segment pointer, and each send displacement points to the same segment of a send buffer. The functions of an allgather operation and an alltoallv operation are defined in the MPI standards promulgated by the MPI Forum. Algorithms for executing collective operations, including the functions of an allreduce operation and an allgather operation, are not defined in the MPI standards.

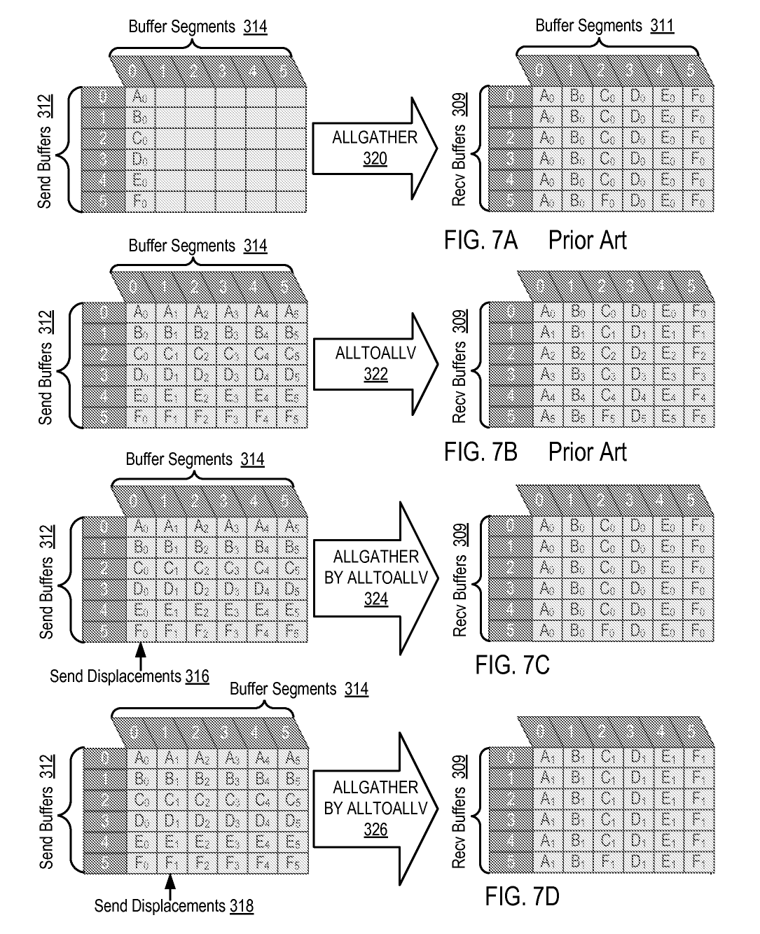

An allgather operation is a collective operation on an operational group of compute nodes that gathers data from send buffers of all compute nodes into receive buffers in all compute nodes in rank order. Each compute node transmits the contents of its send buffer to all nodes of an operational group, including itself. Each compute node upon receiving the data places the data in rank order in its receive buffer. Upon conclusion of an allgather, each compute node's receive buffer contains all the data transmitted stored in order in a receive buffer according to the rank of the compute node from which the data was sent and received. The effect of an allgather is that all receive buffers in all compute nodes of an operational group contain the same data. FIG. 7A, discussed in more detail below, illustrates the function of an allgather operation as defined in the MPI standard.

An alltoallv operation is a collective operation on an operational group of compute nodes that sends data from ranked segments of send buffers of all compute nodes into receive buffers in all compute nodes in rank order. The size of each ranked segment of the send buffer may vary. Each compute node transmits the contents of each ranked segment of its send buffer only to a correspondingly ranked compute node. The contents of ranked segment 0 go to compute node of rank 0. The contents of ranked segment 1 go to compute node of rank 1. And so on. The size of each ranked segment of the send buffer may vary. Each compute node upon receiving the data places it in rank order in a ranked segment of its receive buffer according to the rank of the sending compute node. Data from compute node of rank 0 goes in ranked segment 0. Data from compute node of rank 1 goes in ranked segment 1. And so on. Upon conclusion of an alltoallv, each compute node's receive buffer contains in rank order all the data from correspondingly ranked segments of the send buffers of all compute nodes in the operational group. The effect of an alltoallv is that all receive buffers in all compute nodes of an operational group contain different data, a matrix inversion of the data sent from the send buffers. FIG. 7B, discussed in more detail below, illustrates the function of an alltoallv operation as defined in the MPI standard.

In addition to compute nodes, computer (100) includes input/output (‘I/O’) nodes (110, 114) coupled to compute nodes (102) through one of the data communications networks (174). The I/O nodes (110, 114) provide I/O services between compute nodes (102) and I/O devices (118, 120, 122). I/O nodes (110, 114) are connected for data communications I/O devices (118, 120, 122) through local area network (‘LAN’) (130). Computer (100) also includes a service node (116) coupled to the compute nodes through one of the networks (104). Service node (116) provides service common to pluralities of compute nodes, loading programs into the compute nodes, starting program execution on the compute nodes, retrieving results of program operations on the computer nodes, and so on. Service node (116) runs a service application (124) and communicates with users (128) through a service application interface (126) that runs on computer terminal (122).

The arrangement of nodes, networks, and I/O devices making up the exemplary system illustrated in FIG. 1 are for explanation only, not for limitation of the present invention. Data processing systems capable of executing an allgather operation on a parallel computer according to embodiments of the present invention may include additional nodes, networks, devices, and architectures, not shown in FIG. 1, as will occur to those of skill in the art. The parallel computer (100) in the example of FIG. 1 includes sixteen compute nodes (102); parallel computers capable of executing an allgather operation according to embodiments of the present invention sometimes include thousands of compute nodes. In addition to Ethernet and JTAG, networks in such data processing systems may support many data communications protocols including for example TCP (Transmission Control Protocol), IP (Internet Protocol), and others as will occur to those of skill in the art. Various embodiments of the present invention may be implemented on a variety of hardware platforms in addition to those illustrated in FIG. 1.

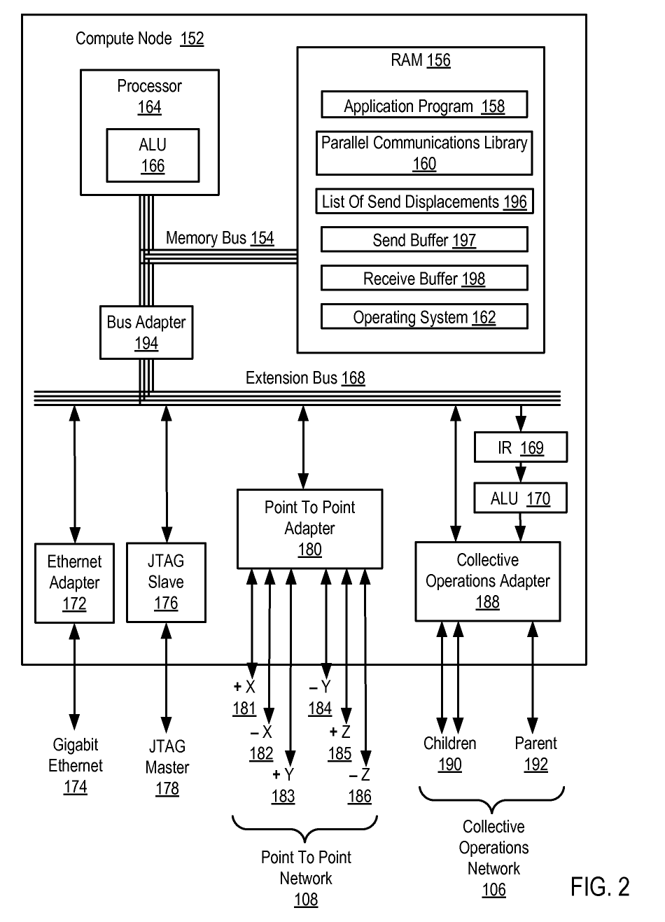

Executing an allgather operation according to embodiments of the present invention is generally implemented on a parallel computer that includes a plurality of compute nodes. In fact, such parallel computers may include thousands of such compute nodes. Each compute node is in turn itself a kind of computer composed of one or more computer processors, its own computer memory, and its own input/output adapters. For further explanation, therefore, FIG. 2 sets forth a block diagram of an exemplary compute node useful in a parallel computer capable of executing an allgather operation according to embodiments of the present invention. The compute node (152) of FIG. 2 includes at least one computer processor (164) as well as random access memory (‘RAM’) (156). Processor (164) is connected to RAM (156) through a high-speed memory bus (154) and through a bus adapter (194) and a extension bus (168) to other components of the compute node.

Stored in RAM (156) is an application program (158), a module of computer program instructions that carries out parallel, user-level data processing using parallel algorithms. Also stored RAM (156) is a parallel communications library (160), a library of computer program instructions that carry out parallel communications among compute nodes, including point to point operations as well as collective operations. Application program (158) executes point to point and collective parallel operations by calling software routines in parallel communications library (160). A library of parallel communications routines may be developed from scratch for use in executing an allgather operation on a parallel computer according to embodiments of the present invention, using a traditional programming language such as the C programming language, and using traditional programming methods to write parallel communications routines that send and receive data among nodes on two independent data communications networks. Alternatively, existing prior art libraries may be used. Examples of prior-art parallel communications libraries that may be improved for executing an allgather operation on a parallel computer according to embodiments of the present invention include the ‘Message Passing Interface’ (‘MPI’) library and the ‘Parallel Virtual Machine’ (‘PVM’) library.

However they are developed, the parallel communications routines of parallel communication library (160) are improved to execute an allgather operation according to embodiments of the present invention by executing an alltoallv operation with a list of send displacements, where each send displacement is implemented as a send buffer segment pointer, and each send displacement points to the same segment of a send buffer. The example RAM configuration (156) of FIG. 2 includes a list of send displacements (196) as well as a send buffer (197) and a receive buffer (198). Send displacements may be implemented as an array of send buffer segment pointers, for example, where each member of the array points to a ranked segment of the send buffer. The segments of the send buffer are ‘ranked’ in the sense that the segments are ordered according to the ranks of the compute nodes in an operational group of compute nodes. So the first send displacement in such an array may point to the first ranked segment of the send buffer, the second send displacement in such an array may point to the second ranked segment of the send buffer, the third send displacement in such an array may point to the third ranked segment of the send buffer, and so on. The ranked segments may be located anywhere in the send buffer. There is no requirement that the ranked segments are contiguous or of the same size. Also stored in RAM (156) is an operating system (162), a module of computer program instructions and routines for an application program's access to other resources of the compute node. It is typical for an application program and parallel communications library in a compute node of a parallel computer to run a single thread of execution with no user login and no security issues because the thread is entitled to complete access to all resources of the node. The quantity and complexity of tasks to be performed by an operating system on a compute node in a parallel computer therefore are smaller and less complex than those of an operating system on a serial computer with many threads running simultaneously. In addition, there is no video I/O on the compute node (152) of FIG. 2, another factor that decreases the demands on the operating system. The operating system may therefore be quite lightweight by comparison with operating systems of general purpose computers, a pared down version as it were, or an operating system developed specifically for operations on a particular parallel computer. Operating systems that may usefully be improved, simplified, for use in a compute node include UNIX™, Linux™, Microsoft XP™, AIX™, IBM's i5/OS™, and others as will occur to those of skill in the art.

The exemplary compute node (152) of FIG. 2 includes several communications adapters (172, 176, 180, 188) for implementing data communications with other nodes of a parallel computer. Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful in systems that execute allgather operations according to embodiments of the present invention include modems for wired communications, Ethernet (IEEE 802.3) adapters for wired network communications, and 802.11b adapters for wireless network communications.

The data communications adapters in the example of FIG. 2 include a Gigabit Ethernet adapter (172) that couples example compute node (152) for data communications to a Gigabit Ethernet (174). Gigabit Ethernet is a network transmission standard, defined in the IEEE 802.3 standard, that provides a data rate of 1 billion bits per second (one gigabit). Gigabit Ethernet is a variant of Ethernet that operates over multimode fiber optic cable, single mode fiber optic cable, or unshielded twisted pair.

The data communications adapters in the example of FIG. 2 includes a JTAG Slave circuit (176) that couples example compute node (152) for data communications to a JTAG Master circuit (178). JTAG is the usual name used for the IEEE 1149.1 standard entitled Standard Test Access Port and Boundary-Scan Architecture for test access ports used for testing printed circuit boards using boundary scan. JTAG is so widely adapted that, at this time, boundary scan is more or less synonymous with JTAG. JTAG is used not only for printed circuit boards, but also for conducting boundary scans of integrated circuits, and is also useful as a mechanism for debugging embedded systems, providing a convenient “back door” into the system. The example compute node of FIG. 2 may be all three of these: It typically includes one or more integrated circuits installed on a printed circuit board and may be implemented as an embedded system having its own processor, its own memory, and its own I/O capability. JTAG boundary scans through JTAG Slave (176) may efficiently configure processor registers and memory in compute node (152) for use in executing allgather operations according to embodiments of the present invention.

The data communications adapters in the example of FIG. 2 includes a Point To Point Adapter (180) that couples example compute node (152) for data communications to a network (108) that is optimal for point to point message passing operations such as, for example, a network configured as a three-dimensional torus or mesh. Point To Point Adapter (180) provides data communications in six directions on three communications axes, x, y, and z, through six bidirectional links: +x (181), −x (182), +y (183), −y (184), +z (185), and −z (186).

The data communications adapters in the example of FIG. 2 includes a Collective Operations Adapter (188) that couples example compute node (152) for data communications to a network (106) that is optimal for collective message passing operations such as, for example, a network configured as a binary tree. Collective Operations Adapter (188) provides data communications through three bidirectional links: two to children nodes (190) and one to a parent node (192).

Example compute node (152) includes two arithmetic logic units (‘ALUs’). ALU (166) is a component of processor (164), and a separate ALU (170) is dedicated to the exclusive use of collective operations adapter (188) for use in performing the arithmetic and logical functions of reduction operations. Computer program instructions of a reduction routine in parallel communications library (160) may latch an instruction for an arithmetic or logical function into instruction register (169). When the arithmetic or logical function of a reduction operation is a ‘sum’ or a ‘logical or,’ for example, collective operations adapter (188) may execute the arithmetic or logical operation by use of ALU (166) in processor (164) or, typically much faster, by use dedicated ALU (170).

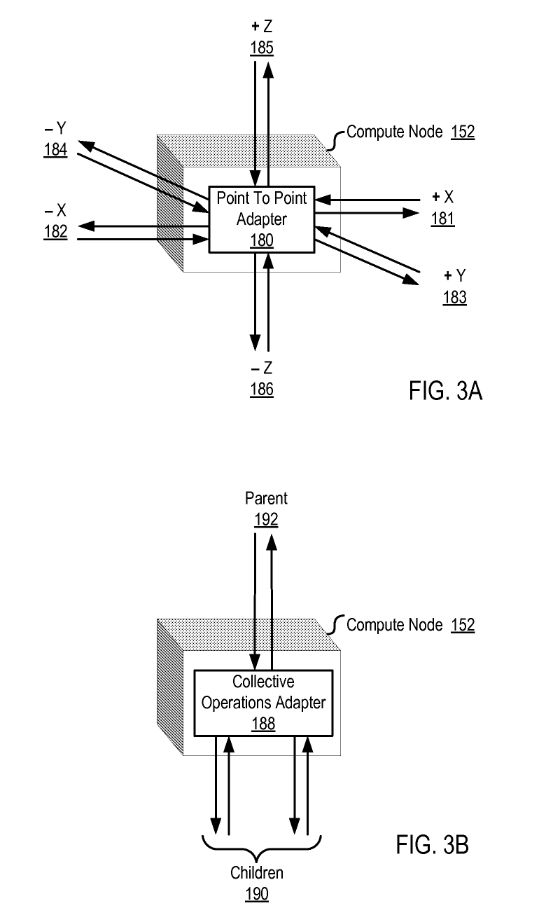

For further explanation, FIG. 3A illustrates an exemplary Point To Point Adapter (180) useful in systems that execute allgather operations according to embodiments of the present invention. Point To Point Adapter (180) is designed for use in a data communications network optimized for point to point operations, a network that organizes compute nodes in a three-dimensional torus or mesh. Point To Point Adapter (180) in the example of FIG. 3A provides data communication along an x-axis through four unidirectional data communications links, to and from the next node in the −x direction (182) and to and from the next node in the +x direction (181). Point To Point Adapter (180) also provides data communication along a y-axis through four unidirectional data communications links, to and from the next node in the −y direction (184) and to and from the next node in the +y direction (183). Point To Point Adapter (180) in also provides data communication along a z-axis through four unidirectional data communications links, to and from the next node in the −z direction (186) and to and from the next node in the +z direction (185).

For further explanation, FIG. 3B illustrates an exemplary Collective Operations Adapter (188) useful in systems that execute allgather operations according to embodiments of the present invention. Collective Operations Adapter (188) is designed for use in a network optimized for collective operations, a network that organizes compute nodes of a parallel computer in a binary tree. Collective Operations Adapter (188) in the example of FIG. 3B provides data communication to and from two children nodes (190) through four unidirectional data communications links (190). Collective Operations Adapter (188) also provides data communication to and from a parent node through two unidirectional data communications links (192).

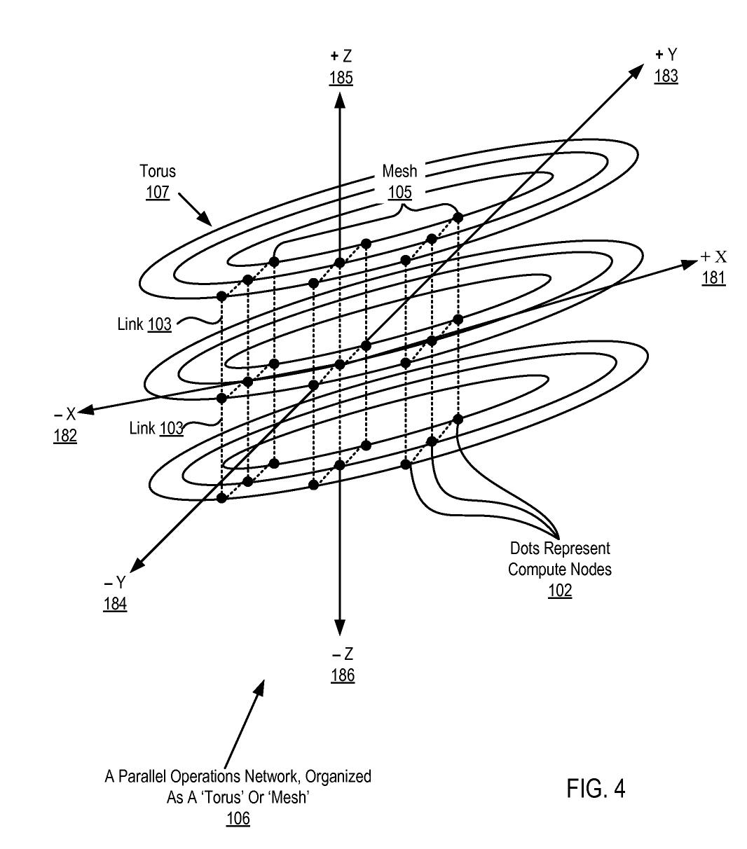

For further explanation, FIG. 4 illustrates an exemplary data communications network optimized for point to point operations (106). In the example of FIG. 4, dots represent compute nodes (102) of a parallel computer, and the dotted lines between the dots represent data communications links (103) between compute nodes. The data communications links are implemented with point to point data communications adapters similar to the one illustrated for example in FIG. 3A, with data communications links on three axes, x, y, and z, and to and fro in six directions +x (181), −x (182), +y (183), −y (184), +z (185), and −z (186). The links and compute nodes are organized by this data communications network optimized for point to point operations into a three dimensional mesh (105) that wraps around to form a torus (107). Each compute node in the torus has a location in the torus that is uniquely specified by a set of x, y, z coordinates. Each compute node is assigned a unit identifier referred to as a ‘rank’ (not shown on FIG. 4). A compute node's rank uniquely identifies the compute node and maps directly to the compute node's x,y,z coordinates in the torus network for use in both point to point and collective operations in the torus network as well as a tree network. Ranks are typically assigned as integers, 0, 1, 2, and so on. For clarity of explanation, the data communications network of FIG. 4 is illustrated with only 27 compute nodes, but readers will recognize that a data communications network optimized for point to point operations for use in executing an allgather operation on accordance with embodiments of the present invention may contain only a few compute nodes or may contain thousands of compute nodes.

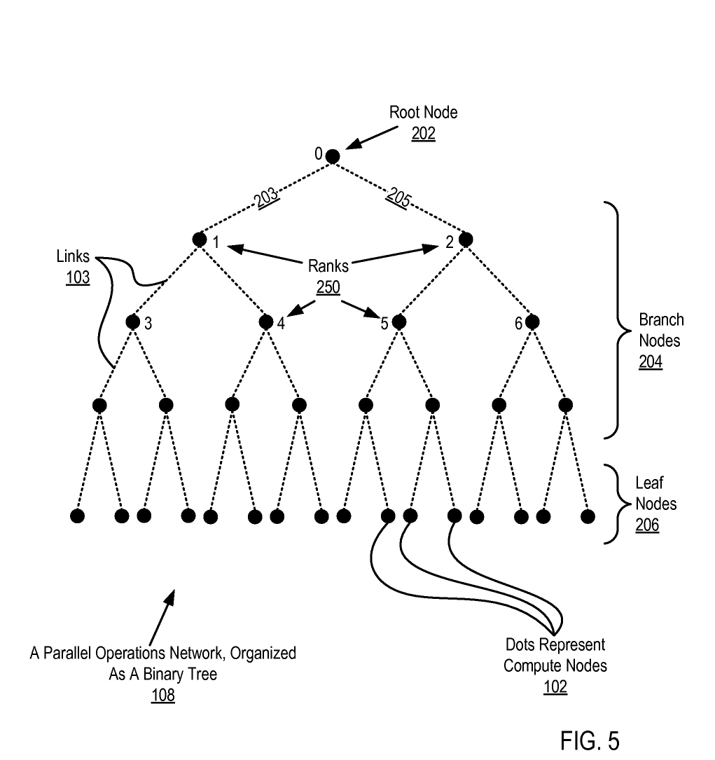

For further explanation, FIG. 5 illustrates an exemplary data communications network (108) optimized for collective operations by organizing compute nodes in a tree. The example data communications network of FIG. 5 includes data communications links connected to the compute nodes so as to organize the compute nodes as a tree. In the example of FIG. 5, dots represent compute nodes (102) of a parallel computer, and the dotted lines (103) between the dots represent data communications links between compute nodes. The data communications links are implemented with collective operations data communications adapters similar to the one illustrated for example in FIG. 3B, with each node typically providing data communications to and from two children nodes and data communications to and from a parent node, with some exceptions. Nodes in a binary tree may be characterized as a root node (202), branch nodes (204), and leaf nodes (206). The root node (202) has two children but no parent. The leaf nodes (206) each has a parent, but leaf nodes have no children. The branch nodes (204) each has both a parent and two children. The links and compute nodes are thereby organized by this data communications network optimized for collective operations into a binary tree (108). For clarity of explanation, the data communications network of FIG. 5 is illustrated with only 31 compute nodes, but readers will recognize that a data communications network optimized for collective operations for use in executing an allgather operation on accordance with embodiments of the present invention may contain only a few compute nodes or may contain thousands of compute nodes.

In the example of FIG. 5, each compute node is assigned a rank (250), a unit identifier that uniquely identifies each compute node's location in the tree network for use in both point to point and collective operations in the tree network. As mentioned above, although the two networks typically operate independently, each compute nodes's rank also maps to the compute nodes's x,y,z coordinates in a torus network. The ranks in this example are assigned as integers beginning with 0 assigned to the root node (202), 1 assigned to the first node in the second layer of the tree, 2 assigned to the second node in the second layer of the tree, 3 assigned to the first node in the third layer of the tree, 4 assigned to the second node in the third layer of the tree, and so on. For ease of illustration, only the ranks of the first three layers of the tree are shown here, but all compute nodes are assigned a unique rank.

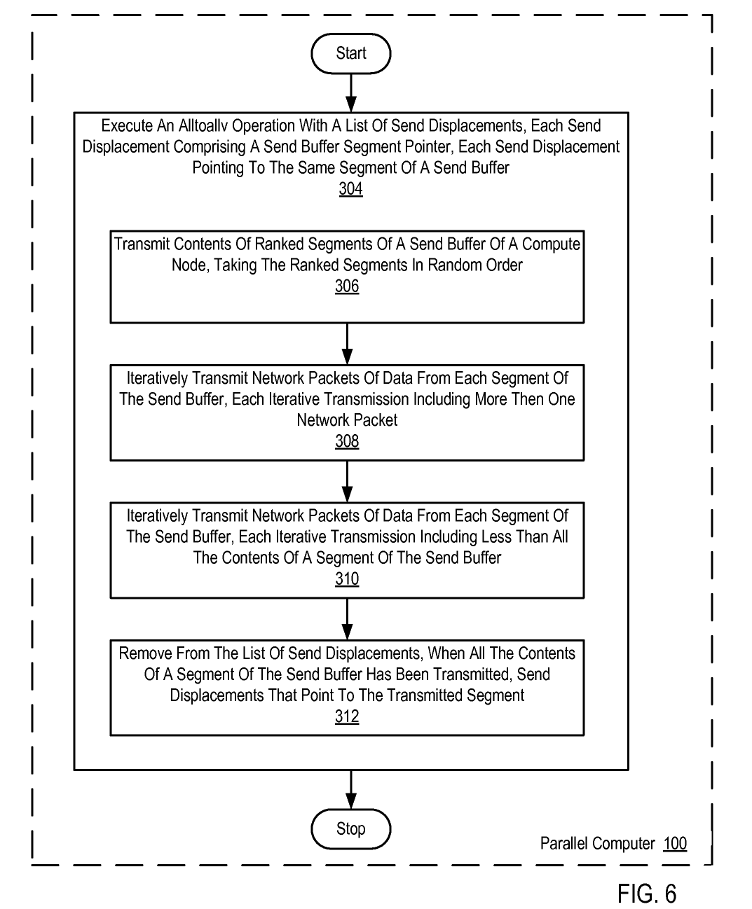

For further explanation, FIG. 6 sets forth a flow chart illustrating an exemplary method for executing an allgather operation in a parallel computer according to embodiments of the present invention. The method of FIG. 6 is carried out on a parallel computer (100) like the one illustrated and described above with reference to FIG. 1. Such a parallel computer includes a plurality of compute nodes, each compute node includes a send buffer, the compute nodes are organized into at least one operational group of compute nodes for collective operations, each compute node in the operational group is assigned a unique rank, and each send buffer is segmented according to the ranks. The method of FIG. 6 is carried out by executing (304) an alltoallv operation with a list of send displacements, where each send displacement is implemented as a send buffer segment pointer, and each send displacement points to the same segment of a send buffer.

Executing (304) an alltoallv operation with a list of send displacements, where each send displacement is implemented as a send buffer segment pointer, and each send displacement points to the same segment of a send buffer may be carried out as illustrated in the following segment of pseudocode.

```
  Datatype sendtype = char;
  Datatype recvtype = char;
  char sendbuffer[1000000];
  int allgather( void *sendbufffer, int sendcount, Datatype sendtype,
    void *recvbuf, int recvcount, Datatype recvtype,
    OpGroup opGroupID)
{
  int sendcounts[3] = {sendcount, sendcount, sendcount};
  int senddisplacements[3] = {sendbuffer, sendbuffer, sendbuffer};
  /* initialize remaining alltoallv( ) parameters */
  int alltoallv( void *sendbuffer, int *sendcounts,
      int *senddisplacements, Datatype sendtype,
      void *recvbufffer, int *recvcounts,
      int *recvdisplacements, Datatype recvtype,
      OpGroup opGroupID );
}
```

The example code segment is ‘pseudocode’ in the sense that it is an explanation in code format rather than an actual computer program listing. The code format is similar to that of the C programming language. In this example, ‘sendbuffer’ is an array of 1,000,000 characters. If the size of a character is two bytes, then sendbuffer represents a 2 megabyte send buffer.

‘Sendtype’ declares the datatype to be stored in and transmitted from the send buffer, in this example, characters. ‘Sendcounts’ is an array of three integer send counts, with each array element initialized to the allgather parameter value of ‘sendcount.’ Each send count represents a number of data elements of sendtype, that is, characters, in each ranked segment of the send buffer. The size of the jth ranked segment of the send buffer is sendcount[j]·sizeof(char).

‘Senddisplacements’ is an array of three send displacements, send buffer segment pointers. Each element of senddisplacemnts[ ] is a pointer that contains the first address in a corresponding ranked segment of the send buffer. Rather than being initialized so:

for (i=0, i=2, i++) senddisplacements[i]=&sendbuffer[i];

the senddisplacements array in this example is initialized so:

int senddisplacements[3]={sendbuffer, sendbuffer, sendbuffer};

with each element of the senddisplacements array pointing to the first segment of the send buffer. Alltoallv( ) iteratively steps through the ranked segments of the send buffer, guided to the ranked segments by the pointer values in the senddisplacements array, and sends to each compute node in an operational group the contents of each ranked segment in turn. In this case, when alltoallv( ) iterates through the senddisplacements array, alltoallv( ) will continue on each iteration to send data from the same ranked segment of the send buffer. That is, in this example, alltoallv( ) will repetitively send the data from the first ranked segment of the send buffer to the compute nodes of an operational group.

For further explanation, FIG. 7A sets forth a block diagram of a prior art allgather operation (320). The allgather operation of FIG. 7A is executed by transmitting data from send buffer (312) of compute nodes of an operation group of six compute nodes ranked 0 through 5. Each send buffer is segmented into six ranked segments (314), 0 through 5. In the example of FIG. 7A, data is transmitted only from the first segment of the send buffers. Each data element is transmitted to each compute node in the operational group. Each transmitted data element is received by each compute node in the operational group and placed in position in the receive buffer (309) according to the rank of the compute node that transmitted the data. A₀, the data from compute node of rank 0 goes into the first position, that is, the 0 position, of the receive buffer in each compute node. B₀, the data from compute node of rank 1 goes into the second position, that is, the 1 position of the receive buffer in each compute node. And so on.

For further explanation, FIG. 7B sets forth a block diagram of a prior art alltoallv operation (322). The alltoallv operation of FIG. 7B is executed by transmitting data from send buffer (312) of compute nodes of an operation group of six compute nodes ranked 0 through 5. The alltoallv operation sends data from ranked segments of send buffers of all compute nodes into receive buffers in all compute nodes in rank order. The size of each ranked segment of the send buffer may vary. Each compute node transmits the contents of each ranked segment of its send buffer only to a correspondingly ranked compute node. The contents of ranked segment 0 go to compute node of rank 0. The contents of ranked segment 1 go to compute node of rank 1. And so on. The size of each ranked segment of the send buffer may vary. Each compute node upon receiving the data places it in rank order in a ranked segment of its receive buffer according to the rank of the sending compute node. Data from compute node of rank 0 goes in ranked segment 0. Data from compute node of rank 1 goes in ranked segment 1. And so on. More particularly, in this example:
A₀, the data from ranked segment 0 of the send buffer of the compute node of rank 0 is transmitted to the compute node of rank 0. A₀, data received from the compute node of rank 0 is stored in ranked segment 0 of the receive buffer of the compute node of rank 0.
A₁, the data from ranked segment 1 of the send buffer of the compute node of rank 0 is transmitted to the compute node of rank 1. A1, data received from the compute node of rank 0 is stored in ranked segment 0 of the receive buffer of the compute node of rank 1.
A₂, the data from ranked segment 2 of the send buffer of the compute node of rank 0 is transmitted to the compute node of rank 2. A₂, data received from the compute node of rank 0 is stored in ranked segment 0 of the receive buffer of the compute node of rank 2.
And so on. Similarly:
B₀, the data from ranked segment 0 of the send buffer of the compute node of rank 1 is transmitted to the compute node of rank 0. B₀, data received from the compute node of rank 1 is stored in ranked segment 1 of the receive buffer of the compute node of rank 0.
B₁, the data from ranked segment 1 of the send buffer of the compute node of rank 1 is transmitted to the compute node of rank 1. B₁, data received from the compute node of rank 1 is stored in ranked segment 1 of the receive buffer of the compute node of rank 1.
B₂, the data from ranked segment 2 of the send buffer of the compute node of rank 1 is transmitted to the compute node of rank 2. B₂, the data received from the compute node of rank 1 is stored in ranked segment 1 of the receive buffer of the compute node of rank 2.

And so on, for all data in all ranked segment of all send buffers of all compute nodes in the operational group. Upon conclusion of the alltoallv operation (322), each compute node's receive buffer contains in rank order all the data from correspondingly ranked segments of the send buffers of all compute nodes in the operational group. The effect of the alltoallv operation (322) is that all receive buffers in all compute nodes of an operational group contain different data, a matrix inversion of the data sent from the send buffers.

For further explanation, FIG. 7C sets forth a block diagram of an exemplary allgather operation (324) executed with an alltoallv according to embodiments of the present invention. The alltoallv operation of FIG. 7C is executed with a list of send displacements, where each send displacement is a send buffer segment pointer, and each send displacement points to the same segment of a send buffer. In this examples, all the send displacements in the list point to ranked send buffer segment 0 (316). The alltoallv operation therefore iteratively traverses the list, attempting to send a series of transmissions of different ranked segments of a send buffer, but instead repeatedly sending out the contents of the same segment of the send buffer. The effect is exactly that of an allgather, as can be seen by comparing FIGS. 7C and 7A. The contents of buffer segment 0 are allgathered by the alltoallv into all the receive buffers (309) of all the compute nodes of the operational group.

For further explanation, FIG. 7D sets forth a block diagram of a further exemplary allgather operation (326) executed with an alltoallv according to embodiments of the present invention. The alltoallv operation of FIG. 7D is executed with a list of send displacements, where each send displacement is a send buffer segment pointer, and each send displacement points to the same segment of a send buffer. The example of FIG. 7D illustrates the fact that although all the send displacements point to the same segment of the send buffer, the send displacements are not required to point to the first segment of the send buffer. In this example, all the send displacements in the list point to ranked send buffer segment 1, the second segment of the send buffer (318). The alltoallv operation iteratively traverses the list, attempting to send a series of transmissions of different ranked segments of a send buffer, but instead repeatedly sending out the contents of the same segment of the send buffer. The effect is exactly that of an allgather, as can be seen by comparing FIGS. 7D and 7A. The contents of buffer segment 1 are allgathered by the alltoallv into all the receive buffers (309) of all the compute nodes of the operational group.

In the method of FIG. 6, executing (304) an alltoallv operation includes transmitting (306) contents of ranked segments of a send buffer of a compute node, taking the ranked segments in random order. Transmitting the contents of ranked segments of a send buffer of a compute node while taking the ranked segments in random order may be carried out by first rearranging segments of a send buffer, previously arranged in rank order, into random order, and then transmitting the contents of each segment of the send buffer in the rearranged order.

TABLE 1

| Random | Segment | Send | Send |
|---|---|---|---|
| Numbers | Ranks | Displacements | Counts |
| 0 | 3 | 032189 | 5 |
| 1 | 5 | 032189 | 5 |
| 2 | 1 | 032189 | 5 |
| 3 | 0 | 032189 | 5 |
| 4 | 4 | 032189 | 5 |
| 5 | 2 | 032189 | 5 |

Table 1 illustrates a list of send displacements associated in table form with corresponding send counts and send buffer segment ranks. The segment ranks, previously arranged in rank order, are now in random order. Each has been assigned a random number, and the records of table 1 have been sorted on the random numbers.

In view of this explanation, readers will recognize that a benefit of transmitting contents of ranked segments of a send buffer of a compute node, taking the ranked segments in random order, is to greatly reduce network congestion during execution of an alltoallv operation. Consider the network of FIG. 5, for example. During the first phase of a traditional alltoallv operation, each compute node transmits the contents of its first buffer segment to the compute node of rank 0, which in this example is root node (202). All the data communications on the network for this period therefore flow through links (203, 205) between compute nodes of ranks 0, 1, and 2, causing a very high degree of network congestion on those links. During the second phase of a traditional alltoallv operation, each compute node transmits the contents of its first buffer segment to the compute node of rank 1, thereby heavily congesting the three links connected to the compute node of rank 1. And so on. The problem is slightly less pronounced on a torus network where all nodes have six inbound links, but the overall problem is the same. Alltoallv is a collective operation, executed at the same time by all compute nodes of an operational group, of which there may be thousands.

When each alltoallv on each compute node transmits contents of ranked segments of a send buffer of a compute node, taking the ranked segments in random order according to embodiments of the present invention, however, very few of the compute nodes will transmit first to the compute node of rank 0. Instead, destinations for the first transmission, and the second transmission, and so on, will be spread randomly around the network, thereby reducing the risk of network congestion.

In the method of FIG. 6, executing (304) an alltoallv operation also includes iteratively transmitting (310) network packets of data from each segment of the send buffer, each iterative transmission including less than all the contents of a segment of the send buffer. Segments of send buffer may contain very large quantities of data. Attempting to send an entire segment of a send buffer all at once to a receiving compute node risks network congestion in the network surrounding that receive node. Iteratively transmitting (310) network packets of data from each segment of the send buffer, each iterative transmission including less than all the contents of a segment of the send buffer, means sending some but not all of the data from segment 0 of a send buffer to receiving compute node 0, some but not all of the data from segment 1 of the send buffer to receiving compute node 1, and so on through all the buffer segments, then looping back to send more data from segment 0, more from segment 1, and so on, until all the data is sent. Sending less than all the data from a segment means tracking where the last transmission ended in the data, which can be carried out by dedicating an additional pointer, referred to here as a ‘current pointer,’ to each segment of the send buffer. Table 2 illustrates a list of send displacements associated in table form with corresponding send counts, send buffer segment ranks, and current pointers.

TABLE 2

| Random | Segment | Send | Send | Current |
|---|---|---|---|---|
| Numbers | Ranks | Displacements | Counts | Pointer |
| 0 | 3 | 032189 | 5 | 036285 |
| 1 | 5 | 032189 | 5 | 036285 |
| 2 | 1 | 032189 | 5 | 036285 |
| 3 | 0 | 032189 | 5 | 036285 |
| 4 | 4 | 032189 | 5 | 036285 |
| 5 | 2 | 032189 | 5 | 036285 |

The quantity of data to be sent from each segment is the send count multiplied by the size of the datatype to be sent. The quantity of data sent in previous iterations is the value of the current pointer minus the value of the send displacement for a segment. Each iteration may compare the total quantity to be sent to the amount sent in previous iterations. After each transmission, iterative code may update the current pointer.

In the method of FIG. 6, executing (304) an alltoallv operation also includes iteratively transmitting (308) network packets of data from each segment of the send buffer, each iterative transmission including more than one network packet. In a data communications network of a parallel computer that uses a network packet size of 256 bytes, for example, transmitting (308) network packets of data from each segment of the send buffer so that each iterative transmission includes more than one network packet may be carried out by transmitting in each iterative transmission at least 512 bytes. Or 1 kilobytes. Or 2 kilobytes. Increasing the transmission size increases the risk of network congestion. Decreasing the transmission size increases the risk of memory cache thrashing. An optimum transmission size may be determined easily through experiment by monitoring cache swaps and application execution speed.

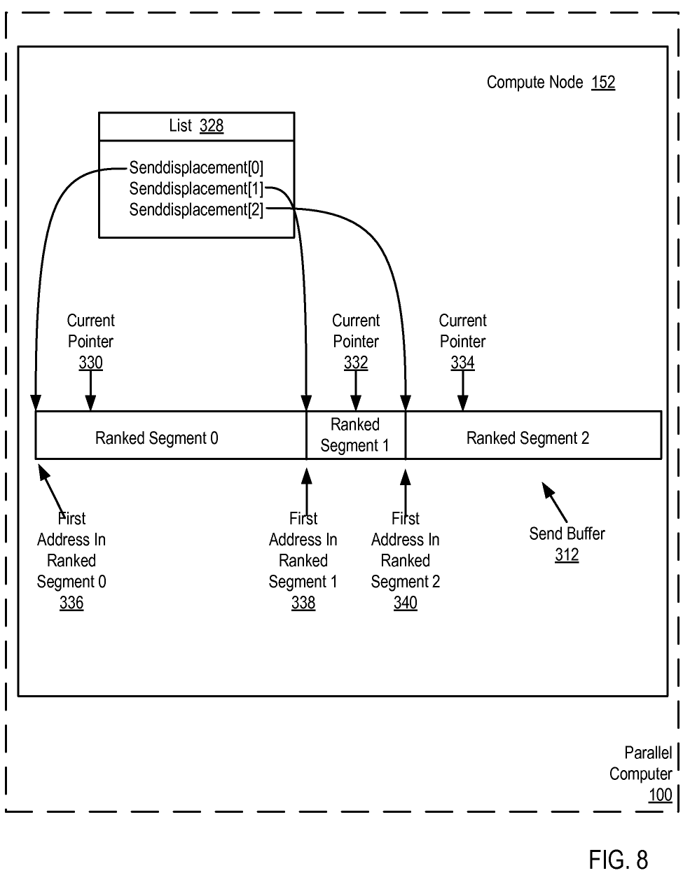

In the method of FIG. 6, executing (304) an alltoallv operation also includes removing (312) from the list of send displacements, when all the contents of a segment of the send buffer has been transmitted, send displacements that point to the transmitted segment. For further explanation, FIG. 8 sets forth a block diagram illustrating execution of an example alltoallv operation on a compute node (152) of a parallel computer (100) according to embodiments of the present invention. The alltoallv of FIG. 8 executes with a list (328) of send displacements, three of them, named respectively senddisplacement[0], senddisplacement[1], and senddisplacement[2]. Each send displacement is a send buffer segment pointer, and in this example, each send displacement points to a different ranked segment of a send buffer (312). The ranked segments of the send buffer are named respectively ‘Ranked Segment 0,’ ‘Ranked Segment 1,’ and ‘Ranked Segment 2.’ Senddisplacement[0] points to the first address in Ranked Segment 0 (336); Senddisplacement[1] points to the first address in Ranked Segment 1 (338); and Senddisplacement[2] points to the first address in Ranked Segment 2 (340).

The ranked segments in this example are specified with different send counts and therefore are of different sizes, with Ranked Segment 1 being clearly the smallest of the three. The alltoallv of FIG. 8 uses current pointers (330, 332, 334) to track how much data has been sent from each ranked segment of the send buffer (312). The alltoallv of FIG. 8 iteratively transmits network packets of data from each segment of the send buffer, each iterative transmission including less than all the contents of a segment of the send buffer. Clearly all the data in Ranked Segment 1 will be sent before all the data of the other two segments has been sent. If the iterative algorithm checks the amount remaining to be sent from each segment on each iteration:

```
while( !Finished)
{
  char *get_next_senddisplacement(char *list);
  {
    calculate total quantity to be sent as send count times size of
    send datatype;
    calculate amount sent as current pointer minus
    senddisplacement;
    if (amount sent is less than total to be sent)
    {
      send more data;
      update current pointer;
    }
  }
}
```

then the data processing involved in the check on Ranked Segment 1 is unnecessary overhead in every iteration after all the data in Ranked Segment 1 has already been sent. Also, the other segments often will be much larger than a smaller segment, rendering repeated iterative processing on a segment whose data has already been sent extremely inefficient. The example alltoallv of FIG. 8, therefore, removes senddisplacement[1] from the list of send displacements (328) when all the contents of Ranked Segment 1 have been transmitted—so that a function such as

char *get_next_senddisplacement(char *list),

for example, will no longer find and return senddisplacement[1] from list (328).

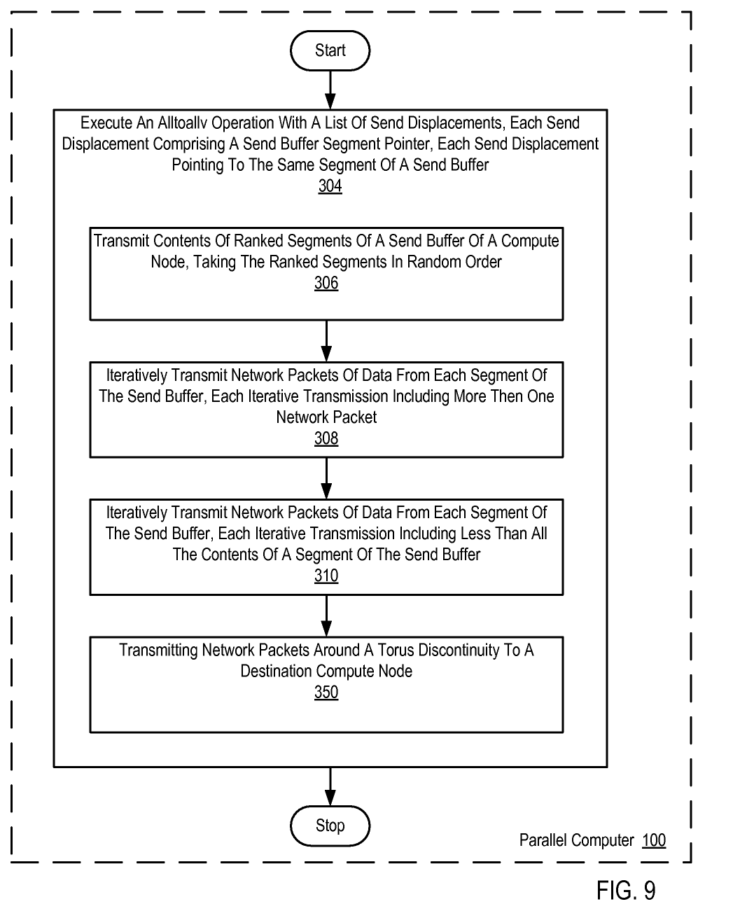

For further explanation, FIG. 9 sets forth a flow chart illustrating a further exemplary method for executing an allgather operation in a parallel computer according to embodiments of the present invention. The method of FIG. 9 is similar to the method of FIG. 6. Like the method of FIG. 6, the method of FIG. 9 is carried out on a parallel computer (100) like the one illustrated and described above with reference to FIG. 1. Such a parallel computer includes a plurality of compute nodes, each compute node includes a send buffer, the compute nodes are organized into at least one operational group of compute nodes for collective operations, each compute node in the operational group is assigned a unique rank, and each send buffer is segmented according to the ranks. Like the method of FIG. 6, the method of FIG. 9 is carried out by executing (304) an alltoallv operation with a list of send displacements, where each send displacement is implemented as a send buffer segment pointer, and each send displacement points to the same segment of a send buffer. Like the method of FIG. 6, in the method of FIG. 9:
executing (304) an alltoallv operation includes transmitting (306) contents of ranked segments of a send buffer of a compute node, taking the ranked segments in random order;
executing (304) an alltoallv operation also includes iteratively transmitting (308) network packets of data from each segment of the send buffer, each iterative transmission including more than one network packet; and
executing (304) an alltoallv operation also includes iteratively transmitting (310) network packets of data from each segment of the send buffer, each iterative transmission including less than all the contents of a segment of the send buffer.
   Unlike the method of FIG. 6, however, in the method of FIG. 9, executing (304) an alltoallv operation includes transmitting (350) network packets around a torus discontinuity to a destination compute node. The method of FIG. 9 is implemented on compute nodes of an operational group of compute nodes in a torus network of a parallel computer like the one described and illustrated with reference to FIG. 4—except that the operation group in which the alltoallv of FIG. 9 executes includes a torus discontinuity.

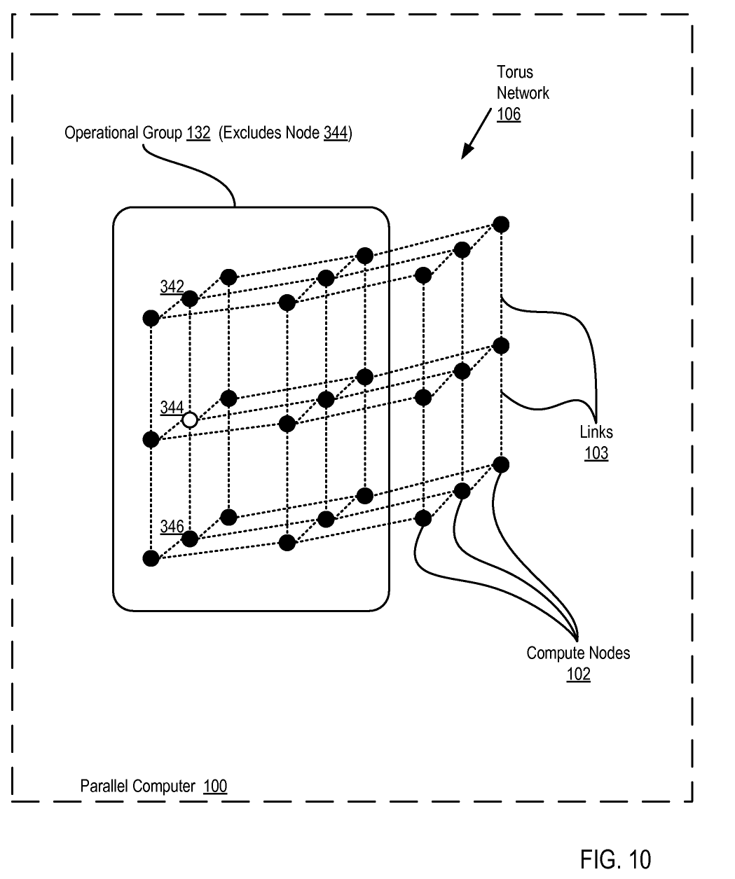

For further explanation, FIG. 10 sets forth a line drawing of an exemplary data communications network of a parallel computer (100) upon which the alltoallv of FIG. 9 may be implemented. The torus network (106) includes an operational group (132) of compute nodes, and the operational group includes a torus discontinuity at node (344). A torus discontinuity is a compute node that is contained within the physical extent of an operational group but is excluded from the definition of the group. A collective operation such as an alltoallv on the compute nodes in the operational group execute on all compute nodes in the group, so that all compute nodes in the group must pass messages to one another. Compute node (344), not defined as part of operational group (132), is not expecting message traffic from the compute nodes in operational group (132). To the extent that compute node (344) is executing part of a parallel application program, receiving unexpected message traffic may cause confusion. Not expecting message traffic from compute nodes in operational group (132), compute node (344) may not forward such traffic correctly. Message traffic between compute node (346) and compute node (342), for example, may therefore usefully be routed around compute node (344) rather than attempting to route such traffic through compute node (344). In fact, for these same reasons, some parallel computer architectures forbid defining operational groups containing such discontinuities. The torus network of FIG. 10, however, supports transmitting (350 on FIG. 9) network packets around a torus discontinuity (344) to a destination compute node (342).

As mentioned above, ranked segments of a send buffer in an alltoallv operation are not required to be all of the same size. In an allgather operation, all transmitted segments are of the same size. In an allgatherv operation, there is again no requirement that all transmissions of buffer segments be of the same size. An allgatherv may be defined with this prototype:

```
int allgatherv( void *sendbuffer, int sendcount,
  Datatype sendtype,
  void *recvbuf, int *recvcounts, int *recvdisplacements,
  Datatype recvtype, OpGroup opGroupID),
```

and all the described functionality and structure for executing an allgather with an alltoallv in this paper applies fully to the allgatherv. That is, the exemplary methods of executing an allgather with an alltoallv described in this paper are also exemplary methods of executing an allgatherv with an alltoallv.

Exemplary embodiments of the present invention are described largely in the context of a fully functional computer system for executing an allgather operation in a parallel computer. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of executing an allgather operation on a parallel computer, the method comprising:
executing an alltoallv operation with a list of send displacements, each send displacement comprising a send buffer segment pointer, each send displacement pointing to the same segment of a send buffer,
wherein:
executing an alltoallv operation further comprises transmitting contents of ranked segments of a send buffer of a compute node, taking the ranked segments in random order, and
the parallel computer comprises a plurality of compute nodes, each compute node comprises a send buffer, the compute nodes are organized into at least one operational group of compute nodes for collective operations, each compute node in the operational group is assigned a unique rank, and each send buffer is segmented according to the ranks.

2. The method of claim 1 wherein executing an alltoallv operation further comprises iteratively transmitting network packets of data from each segment of the send buffer, each iterative transmission including more than one network packet.

3. The method of claim 1 wherein executing an alltoallv operation further comprises iteratively transmitting network packets of data from each segment of the send buffer, each iterative transmission including less than all the contents of a segment of the send buffer.

4. A method of executing an allgatherv operation on a parallel computer, the method comprising:
executing an alltoallv operation with a list of send displacements, each send displacement comprising a send buffer segment pointer, each send displacement pointing to the same segment of a send buffer,
wherein:
executing an alltoallv operation further comprises transmitting contents of ranked segments of a send buffer of a compute node, taking the ranked segments in random order, and
the parallel computer comprises a plurality of compute nodes, each compute node comprises a send buffer, the compute nodes are organized into at least one operational group of compute nodes for collective operations, each compute node in the operational group is assigned a unique rank, and each send buffer is segmented according to the ranks.

5. The method of claim 1 wherein executing an alltoallv operation further comprises iteratively transmitting network packets of data from each segment of the send buffer, each iterative transmission including more than one network packet.

6. The method of claim 1 wherein executing an alltoallv operation further comprises iteratively transmitting network packets of data from each segment of the send buffer, each iterative transmission including less than all the contents of a segment of the send buffer.

7. A computer program product for executing an allgather operation in a parallel computer, the computer program product disposed upon a signal bearing medium, the computer program product comprising computer program instructions capable of:
executing an alltoallv operation with a list of send displacements, each send displacement comprising a send buffer segment pointer, each send displacement pointing to the same segment of a send buffer,
wherein:
executing an alltoallv operation further comprises transmitting contents of ranked segments of a send buffer of a compute node, taking the ranked segments in random order, and
the parallel computer comprises a plurality of compute nodes, each compute node comprises a send buffer, the compute nodes are organized into at least one operational group of compute nodes for collective operations, each compute node in the operational group is assigned a unique rank, and each send buffer is segmented according to the ranks.

8. The computer program product of claim 6 wherein the signal bearing medium comprises a recordable medium.

9. The computer program product of claim 6 wherein the signal bearing medium comprises a transmission medium.

10. The computer program product of claim 6 wherein executing an alltoallv operation further comprises iteratively transmitting network packets of data from each segment of the send buffer, each iterative transmission including more than one network packet.

11. The computer program product of claim 6 wherein executing an alltoallv operation further comprises iteratively transmitting network packets of data from each segment of the send buffer, each iterative transmission including less than all the contents of a segment of the send buffer.

12. A method of executing an alltoallv operation on a parallel computer,
wherein the parallel computer comprises a plurality of compute nodes, each compute node comprises a send buffer, the compute nodes are organized into at least one operational group of compute nodes for collective operations, each compute node in the operational group is assigned a unique rank, each send buffer is segmented according to the ranks, the alltoallv operation comprises a list of send displacements, and each send displacement comprises a send buffer segment pointer,
the method comprising:
transmitting in random order ranked segments of a send buffer of a compute node; and
removing from the list of send displacements, when all the contents of a segment of the send buffer have been transmitted, a send displacement that points to the transmitted segment.

13. The method of claim 12 further comprising iteratively transmitting network packets of data from each segment of the send buffer, each iterative transmission including more than one network packet.

14. The method of claim 12 further comprising iteratively transmitting network packets of data from each segment of the send buffer, each iterative transmission including less than all the contents of a segment of the send buffer.

15. The method of claim 12 wherein:
the parallel computer further comprises a data communications network for data communication among the nodes, the network effectively organizing the nodes in a torus;
the operational group of compute nodes includes a torus network discontinuity; and
the method further comprises transmitting network packets around the discontinuity to a destination compute node.

16. A computer program product for executing an alltoallv operation in a parallel computer, wherein the parallel computer comprises a plurality of compute nodes, each compute node comprises a send buffer, the compute nodes are organized into at least one operational group of compute nodes for collective operations, each compute node in the operational group is assigned a unique rank, each send buffer is segmented according to the ranks, the alltoallv operation comprises a list of send displacements, each send displacement comprises a send buffer segment pointer, the computer program product is disposed upon a signal bearing medium, and the computer program product comprises computer program instructions capable of:
transmitting in random order ranked segments of a send buffer of a compute node; and
removing from the list of send displacements, when all the contents of a segment of the send buffer have been transmitted, a send displacement that points to the transmitted segment.

17. The computer program product of claim 16 wherein the signal bearing medium comprises a recordable medium.

18. The computer program product of claim 16 wherein the signal bearing medium comprises a transmission medium.

19. The computer program product of claim 16 further comprising computer program instructions capable of iteratively transmitting network packets of data from each segment of the send buffer, each iterative transmission including more than one network packet.

20. The computer program product of claim 16 further comprising computer program instructions capable of iteratively transmitting network packets of data from each segment of the send buffer, each iterative transmission including less than all the contents of a segment of the send buffer.
